(19) United States
(12) Patent Application Publication
(10) Pub. No.: US 2014/0101002 A1
(43) Pub. Date: Apr. 10, 2014

(54) INTELLIGENT HANDLING OF UNSTRUCTURED DATA ITEMS

(71) Applicants: Carsten Schmitt, Walldorf (DE); Tina Marseille, Walldorf (DE)

(72) Inventors: Carsten Schmitt, Walldorf (DE); Tina Marseille, Walldorf (DE)

(21) Appl. No.: 13/647,060

(22) Filed: Oct. 8, 2012

(51) Int. Cl. G06Q 40/00

(52) U.S. Cl. CPC G06Q 40/10
USPC 705/30

(57) ABSTRACT

Systems and methods for intelligent handling of one or more unstructured data items may include receiving a request for a buffer. A context for the request may be determined. A sorting input may be received. Based upon the sorting input, a determination of one or more unstructured data items may be made. The determination may be made based upon comparing the sorting input with one or more data elements of each unstructured data item. One or more of the unstructured data items may be associated with a grouping.

### BACKGROUND

With rapidly expanding businesses, many employers and/or employees incur various expenses during the performance of the employees job duties. For example, in some instances an employee may need to travel away from their employer's office as part of their job and/or incur costs during other aspects of their job function. In incurring the expenses, the employee may spend their own money, such as by charging a personal credit card, for which the employer may reimburse the employee. In other situations, the employer may incur the expenses directly. In still other situations, both the employer and the employee may incur some expenses. In other instances, the employer and/or employee may incur expenses without travelling that may be tracked and/or reimbursed (e.g., a business telephone bill). Such expenses may be entered as individual expense items into a travel and expense management system and/or otherwise submitted to the employer. For example, while an employee is travelling the expenses may be entered via a mobile application on a smart phone or tablet computer, the expenses may be documented textually or visually (e.g., an image of a receipt) by an e-mail or other message, or the expenses may be based upon a credit card feed. Such expense items may be added to an expense report for submission for reimbursement.

### SUMMARY

One implementation relates to a method for intelligent handling of one or more unstructured data items. The method may include receiving a request for a buffer having one or more unstructured data items. A determination of a context for the request for the buffer may be made and a sorting input may be received. A determination of one or more unstructured data items having one or more data elements may be made based, at least in part, on the sorting input by comparing the sorting input with a data element, and the unstructured data items may be associated with an expense report.

In another implementation, a tangible computer-readable storage medium may include instructions for receiving a request for an expense buffer having one or more expense items. A determination of a context for the request for the expense buffer may be made. A sorting input of a date, a date range, a location, a type, or an amount may be received. A determination of one or more expense items may be based on the sorting input by comparing the sorting input with a data element of the expense items. The determined expense items may be displayed and a selection of a data element may be received. The selected expense items may be associated with an expense report.

In a further implementation, a computerized method may include receiving a request for a buffer having multiple expense items. A determination may be made of the context, such as from a homepage user interface or from an expense report user interface, of the request for the buffer. A sorting input, such as a date, a date range, a location, a type, or an amount, may be received to determine one or more expense items by comparing the sorting input with a data element of each expense item. The determined expense items may be associated with an expense report.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of a system having a plurality of computing devices connected to a server via a network;

FIG. 3 is an overview of a plurality of unstructured expense items;

FIG. 4 is an overview of an example expense report homepage environment;

FIG. 5 is an overview of an example expense report environment;

FIG. 6 is an example process for intelligent handling of unstructured data items;

FIG. 7 is an example interface for intelligent handling of unassigned expenses based on a sorting input; and

FIG. 8 is an example interface for intelligent handling of unassigned expenses based on an associated expense report.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

In some instances, it may be useful to sort items based upon associated characteristics. Some example characteristics which may be used to sort items include dates, locations, types, amounts, etc. In some instances, such sorting may permit a user to more efficiently group items together to form a group having similar characteristics. In other instances, if a group already exists, the one or more characteristics of the group may be used to sort items that have not been assigned the group. Such intelligent handling of items based upon similar characteristics and/or based upon characteristics of a group may allow a user to more efficiently allocate the items.

In one example, a plurality of expense items may be entered into a travel and expense management system. In some instances, the expense items may be entered manually by a user, such as by typing in the expense type, the expense amount, attaching an image of the receipt, etc. In some instances, expense items may be input and/or recorded while a user is traveling in order to record or otherwise keep track of the expense items as they occur. This may be useful when a user is traveling and incurring a number of expenses over a long trip. In still further instances, the expense items may be unrelated to travel (e.g., general business expenses such as monthly bills for a business phone and/or purchases for the business) and are entered into the expense management system. Some example ways in which a user may record or otherwise keep track of their expense items may include entering the expenses items via a mobile application on a smart phone, tablet computer, or the like, documenting the expense items textually or visually (e.g., an image of a receipt) by an e-mail or other message, or the expenses may be recorded or otherwise tracked using a credit card feed.

In some instances, unallocated expense items (e.g., expense items that have not been associated with an expense report) may be included in an expense buffer (e.g., a list of unallocated expense items). After a long trip or series of trips, the expense buffer may include a number of expense items for the user to sort through and allocate to expense reports. Accordingly, it may be advantageous to sort or otherwise organize the number of expense items in the expense buffer such that a user may allocate related expense items quickly and efficiently for an expense report.

In one implementation, the expense items in the expense buffer may be sorted by date and/or only expense items associated with a date range (such as the dates of a specific trip) may be shown such that a user may select and allocate the expense items to an existing expense report or create a new expense report associated with those expense items. In another implementation, the expense items may be sorted by location (e.g., by city, state, country, region, or the like) and/or the display of expense items in the expense buffer may be limited by the location associated with each expense item such that a user may select and allocate the expense items to an existing expense report having a similar location or create a new expense report associated with those expense items. In another implementation, the expense items may be sorted by a type associated with each expense item (e.g., meals, travel, gifts, hotels, mileage, or the like) and/or the display of expense items in the expense buffer may be limited by the type associated with each expense item such that a user may select and allocate the expense items to an existing expense report or create a new expense report associated with those expense items. In yet a further version, the expense items of the expense buffer may be sorted by location and date, date and type, type and location, and/or location, date, and type. Of course, still further characteristics and/or combinations or subcombinations of characteristics may be utilized to sort and/or otherwise limit the display of expense items in the expense buffer.

In some instances, it may also be advantageous to be able to sort and/or allocate one or more expense items automatically based on one or more characteristics of an existing expense report and one or more characteristics of the one or more expense items. For example, when a user is accessing an existing expense report, a characteristic of the expense report may be specified in order to sort and/or limit the display of expense items in the expense buffer. For example, a specified date range for an existing report may be utilized to sort and/or limit the display of expense items based upon the relatedness of the date of each expense item in the expense buffer. In another example, a location associated with an existing expense report may be used to sort and/or limit the display of expense items based upon the relatedness of the location, if provided, of each expense item in the expense buffer. In yet another example, a type associated with an existing expense report (e.g., an expense report for all meals, all travel, all hotels, etc.) may be used to sort and/or limit the display of the expense items based upon the relatedness of the type of each expense item in the expense buffer. Of course, still further characteristics and/or combinations or subcombinations of characteristics of an expense report may be utilized to sort and/or otherwise limit the display of expense items in the expense buffer.

It should be understood that the foregoing sorting and/or limiting of the display of items may be applied in other contexts where intelligent handling of a plurality of items may be desirable.

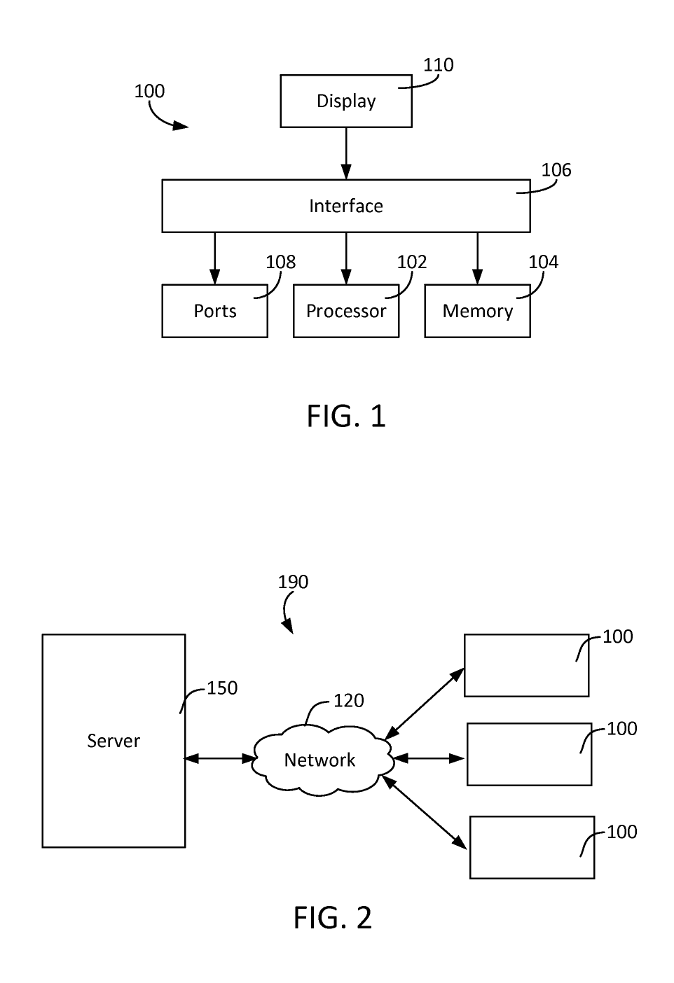

FIG. 1 is a block diagram of a computing device 100 that may be used to implement the systems and methods in accordance with the implementations described herein, as either a client or as a server or plurality of servers. Computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and may be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by device 100, and wireless communication by device 100. Processor 102 may communicate with a user via interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may receive commands (e.g., voice-activated, text, etc.), from a user and convert them to provide to the processor 102.

In addition, the interface 106 may be provided to communicate with processor 102 and enable near area communication of device 100 with other devices. The interface 106 may provide, for example, for wired communication. In some implementations, multiple interfaces may be used. Computing device 100 may communicate wirelessly through interface 106, which may include digital signal processing circuitry where necessary. Interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 100, which may be used as appropriate by applications running on device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, a propagated signal, etc. Expansion memory may be provided and connected to device 100 through interface 106.

Referring to FIG. 2, in some versions, a plurality of computing devices 100 may be connected to one or more servers 150 via a network 120 to form a system 190. Network 120 may be any form of computer network that relays information between computing devices 100 and server 150. For example, network 120 may include the Internet and/or other types of data networks, such as a local area network (LAN), a wide area network (WAN), a cellular network, satellite network, or other types of data networks. Network 120 may also include any number of computing devices (e.g., computer, servers, routers, network switches, etc.) that are configured to receive and/or transmit data within network 120. Network 120 may further include any number of hardwired and/or wireless connections. For example, computing devices 100 may communicate wirelessly (e.g., via WiFi, cellular, radio, etc.) with a transceiver that is hardwired (e.g., via a fiber optic cable, a CATS cable, etc.) to other computing devices in network 120.

Server 150 may also be any number of different types of electronic devices configured to communicate via network 120 (e.g., a laptop computer, a desktop computer, a tablet computer, a smart phone, a server, combinations thereof, etc.). Server 150 may be configured in substantially the same way as computing device 100 or server 150 may have other configurations. Server 150 may include a processor and a memory, i.e., a processing circuit. The memory may store machine instructions that, when executed by the processor cause the processor to perform one or more of the operations described herein. The processor may include a microprocessor, ASIC, FPGA, etc., or combinations thereof. The memory may include, but is not limited to, electronic, optical, magnetic, or any other storage or transmission device capable of providing the processor with program instructions. The memory may include a floppy disk, CD-ROM, DVD, magnetic disk, memory chip, ROM, RAM, EEPROM, EPROM, flash memory, optical media, or any other suitable memory from which the processor can read instructions.

In some versions, system 190 may be implemented and/or integrated into an enterprise architecture. Of course system 190 is merely and example and other systems may be used with the methods and processes described herein.

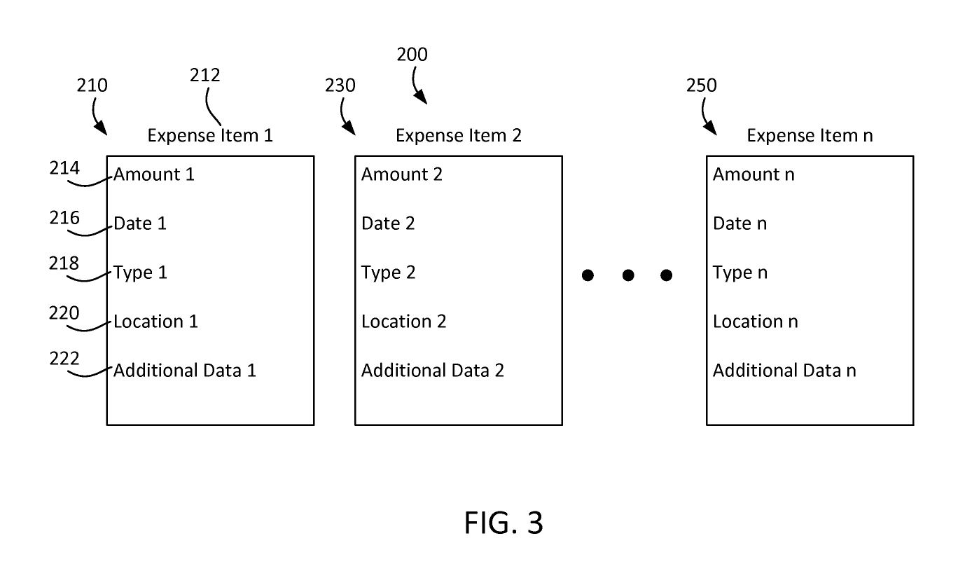

Referring to FIG. 3, a plurality of data items are shown as expense items 210, 230, 250. It should be understood that the data items may be any form of data items and are not limited to expense items. An example expense item 210 includes a plurality of data elements, including a title 212, an amount 214, a date 216, a type, 218, a location 220, and any additional data 222. For data items that are not expense items 210, 230, 250, other data elements may be used (e.g., an e-mail have data elements for a date, a from entity, a subject, a to entity, etc.).s Any of the foregoing data may be omitted, altered, added, or otherwise for each expense item 210. In some instances, expense items 210, 230, 250 may be automatically generated. For example, a credit card feed may be monitored and each transaction may result in the generation of an expense item 210, 230, 250. The plurality of data elements may also be automatically entered by the automated system for each expense item 210, 230, 250 based upon the information in the credit card feed and/or through other automated processes. For example, the credit card feed may include a location for the transaction, a date, an amount, and other data. Such items may be utilized for amount 214, date 216, location 220, and/or additional data 222. In addition, in some versions a title 212 and a type 218 may be generated based upon a title for the credit card transaction, based upon a type of establishment associated with the transaction and/or other data (e.g., a restaurant transaction at 7 P.M. may be indicative of a dinner meal type expense, a hotel transaction with a credit card transaction title include the word “room” may be indicative of a lodging type expense). In other versions, image files for scanned receipts may have optical character recognition performed on the image to extract data from the receipt to generate each expense item and/or any or all of the plurality of data elements. In other versions, expense items 210, 230, 250 and/or the plurality of data elements may be manually created by a user. Still other ways of generating expense items 210, 230, 250 and/or inputting one or more of the plurality of data elements may be implemented.

In some instances, one or more of the data items may be automatically associated with a grouping. For example, each expense item 210, 230, 250 may automatically be associated with an expense report. In some instances, the automatic association of an expense item 210, 230, 250 with an expense report may be based upon one or more rules using one or more of the plurality of data elements of the expense item 210, 230, 250 and data associated with the expense report. For instance, if an expense report has one or more associated dates (e.g., Jan. 1, 2012 through Jan. 4, 2012), an expense item 210 having a date 216 on or within the range of the one or more dates of the expense report may be automatically associated with that expense report. In other versions, the location 220, amount 214, type 218, and/or other data elements of the expense item 210, 230, 250 may be used with one or more aspects of the expense report to automatically associate the expense item 210, 230, 250 with the expense report. Of course, other information for such automatic association may be utilized as well.

If no expense report exists to automatically associate an expense item 210 with an expense report or if other user input is needed for the expense item 210, 230, 250 (e.g., adding in additional data, approving the addition of the expense item, or the like), then the expense item 210 may be added to an expense buffer 200. As shown in FIG. 3, expense buffer 200 may include a first expense item 210 through an nth expense item 250. It should be understood that expense buffer 200 may comprise any number of expense items 210, 230, 250 or may have no expense items. Expense buffer 200 thus contains any expense items 210, 230, 250 that have been created, but have not been associated with an expense report. In some instances, the number of expense items 210, 230, 250 in expense buffer 200 may become very large. Thus, it may be advantageous to a user to provide a way to sort and/or otherwise assist the user in allocating the unallocated expense items 210, 230, 250 of expense buffer 200. Of course ,such intelligent handling of the unallocated expense items 210, 230, 250 may be used even when expense buffer 200 includes a small number of expense items 210, 230, 250. It should further be understood that other unstructured data items other than expense items 210, 230, 250 may be included in expense buffer 200 and/or in any other buffer.

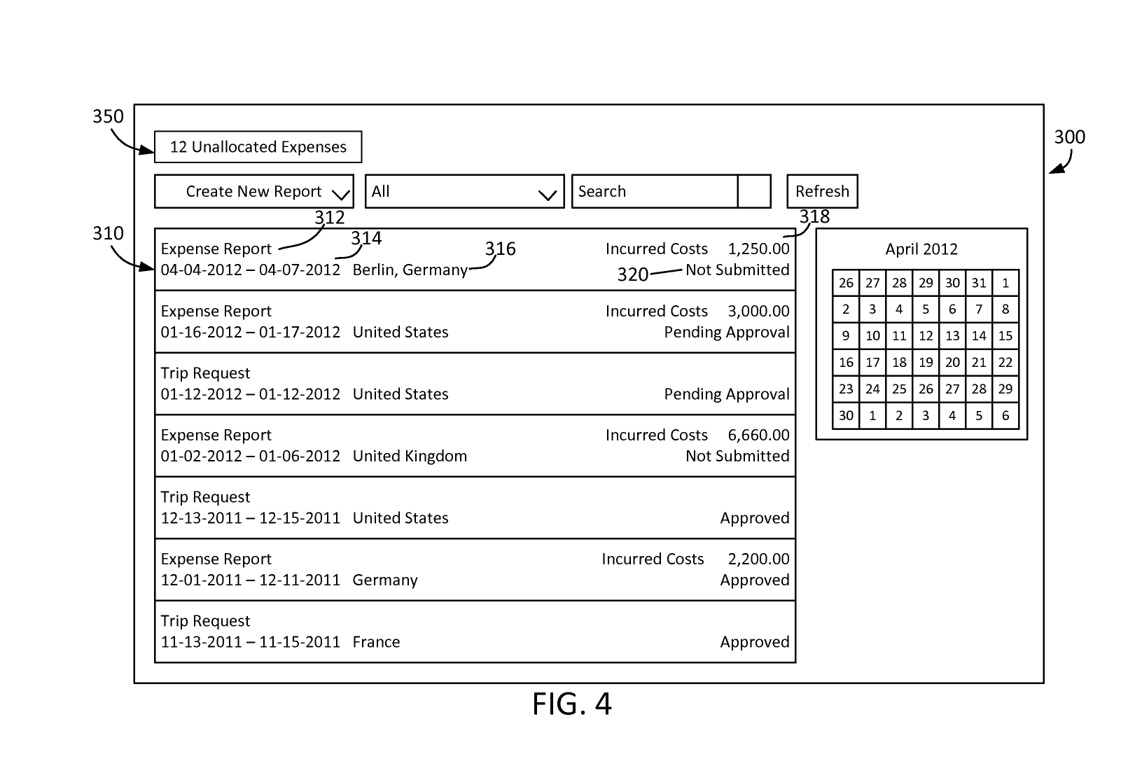

In some instances, expense items, such as expense items 210, 230, 250, and expense reports may be created, modified, submitted, and/or otherwise interacted with by a user using an application or other user interface. Referring to FIG. 4, an example expense report homepage user interface 300 is shown. User interface 300 may be displayed on a display of a computing device, such as display 110 of computing device 100 described above. In some instances, environment 300 may be part of an application that is locally run on computing device 100 and displayed via display 110. The user may utilize one or more input devices associated with computing device 100 to provide input or otherwise interact with user interface 300. In other instances, user interface 300 may be remotely run, such as on another computing device 100 and/or on server 150 of system 190. Display data for user interface 300 may be transmitted via network 120 to computing device 100 to present user interface 300 to the user via a local display 110. The user may utilize one or more input devices associated with computing device 100 to provide input or otherwise interact with user interface 300 via network 120.

User interface 300 of the present example may include one or more expense report objects 310, one or more trip requests, a calendar, a search feature, a refresh button, a sorting feature, a new item creation feature, and an unallocated expenses feature 350. In the present example, expense report objects 310 may comprise a selectable object that includes data indicative of a title 312, date 314, location 316, total cost 318, and status 320. Title 312 may be defined by a user to describe the item, such as “Expense Report—Trip to Germany” or the like, or may be automatically generated when the expense report object 310 is created. Date 314 may also be defined by the user when the expense report object 310 is created. In the example shown, date 314 comprises a start date and end date to create a date range for the expense report object 310. Location 316 may also be defined by the user when the expense report object 310 is created. Total cost 318 may be a sum of one or more amounts for expense items, such as expense items 210, 230, 250 described above, that are associated with expense report object 310. Status 320 may be an indicator of the status of expense report object 310 (e.g., Not Submitted, Pending Approval, Approved, or the like). Of course, any or all of the foregoing aspects of expense report object 310 may be omitted, modified, added, or otherwise.

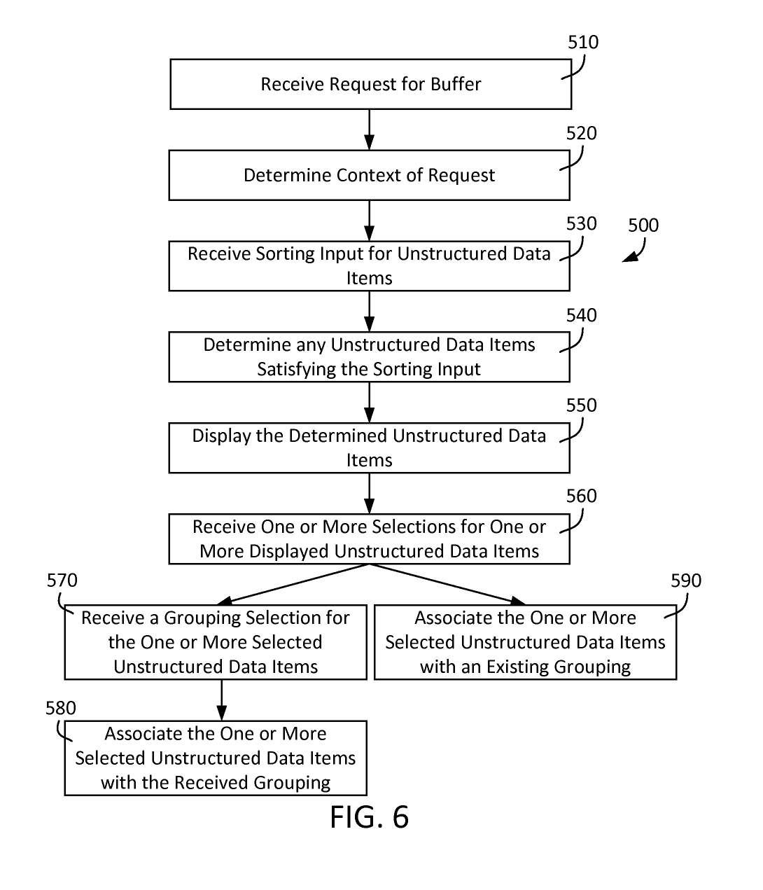

Unallocated expense feature 350 may be included in user interface 300 to provide an indication of the number of expense items in expense buffer, such as expense buffer 200 of FIG. 2. In some instances, selection of unallocated expense feature 350 may initiate a process, such as process 500 of FIG. 6, described in greater detail below. Of course, other items, features, buttons, etc. may be included in user interface 300 and the foregoing is merely an example.

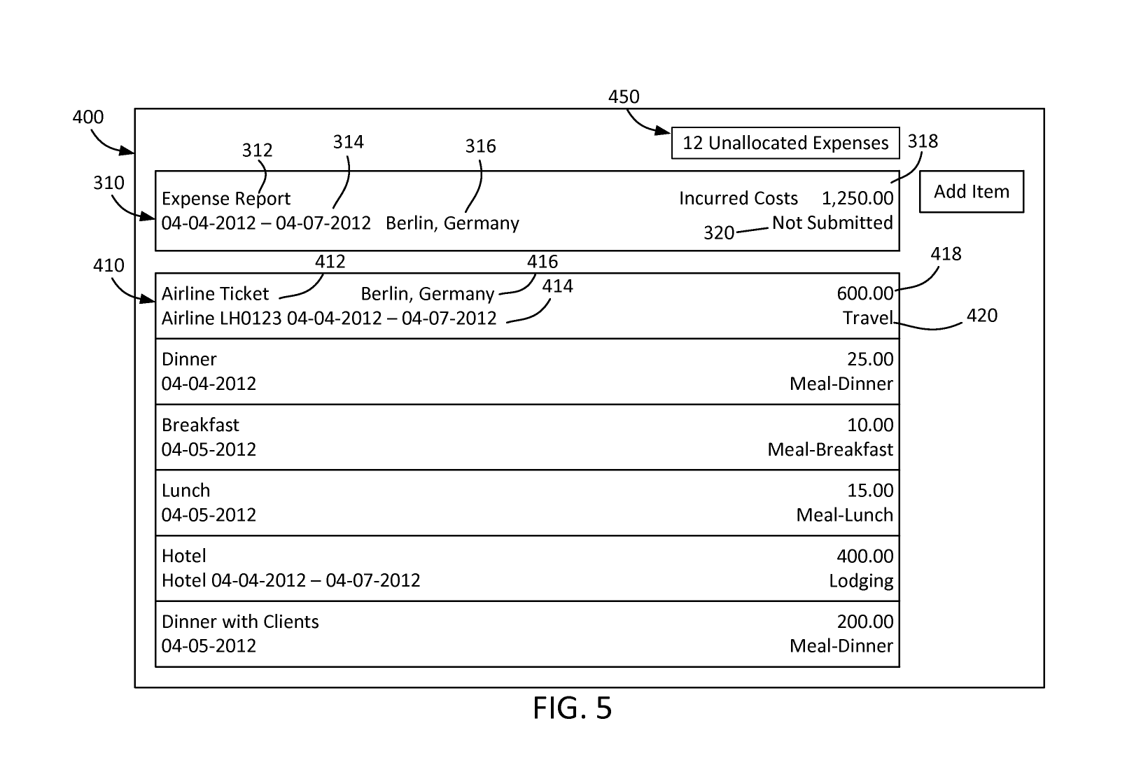

Selection of an expense report object 310 of user interface 300 may present the user with another user interface 400, such as that shown in FIG. 5, for viewing, modifying, adding, deleting, or otherwise interacting with the selected expense report object 310. As shown in FIG. 5, user interface 400 may include the selected expense report object 310 having data indicative of the title 312, one or more dates 314, location 316, total cost 318, and status 320 at a top portion of user interface 400, one or more expense items 410 that have been associated with expense report object 310, an add item feature, and an unallocated expenses feature 450. Expense items 410 may be similar to expense items 210, 230, 250 and may include a plurality of data elements for a title 412, one or more dates 414, a location 416, an amount 418, a type 420, and/or any other data. Unallocated expense feature 450 may be included in environment 400 to provide an indication of the number of expense items in expense buffer, such as expense buffer 200 of FIG. 2. In some instances, selection of unallocated expense feature 450 may initiate a process, such as process 500 of FIG. 6, described in greater detail below. Of course, other items, features, buttons, etc. may be included in user interface 400 and the foregoing is merely an example.

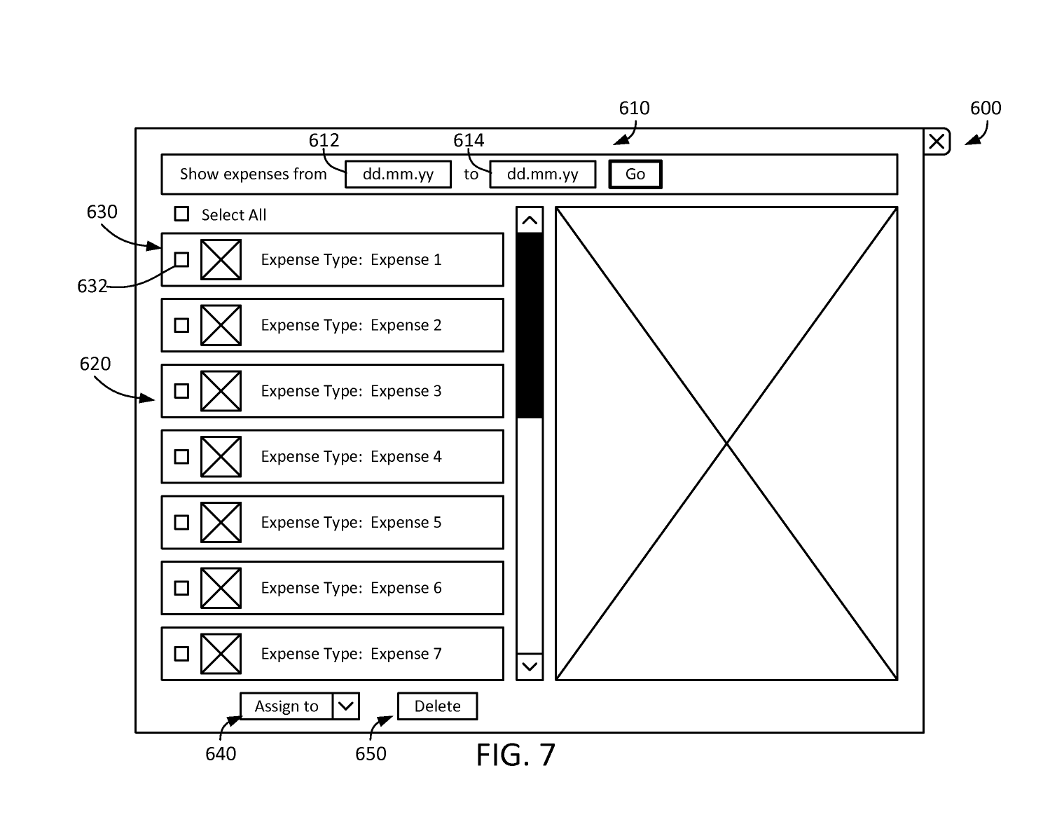

Referring to FIG. 6, an example process 500 for intelligently handling unstructured data items is shown. Process 500 is shown in general terms such that process 500 may be applied to any form of unstructured data elements; however, a specific example relating to the intelligent handling of expense items will be described herein. Process 500 may begin with receiving a request for the buffer (step 510). In some versions, a context for the request may be determined based upon how process 500 is initiated (step 520). For example, in the instance of expense items and/or expense reports, if process 500 is initiated using unallocated expense feature 350 from the homepage user interface 300, then a first user interface, such as user interface 600 shown in FIG. 7, may be presented to the user such that the user may be prompted to provide one or more sorting inputs. Examples of such sorting inputs may include a date, a date range, a location, an expense type, an expense amount, an expense amount range, and/or any other sorting input associated with an expense item and/or any other unstructured data item. Of course, multiple sorting inputs may be provided, such as a date range and location, a date and location, a date range and expense type, etc. Thus, a user may specify the sorting input to be applied to the unallocated expense items and/or other unstructured data items.

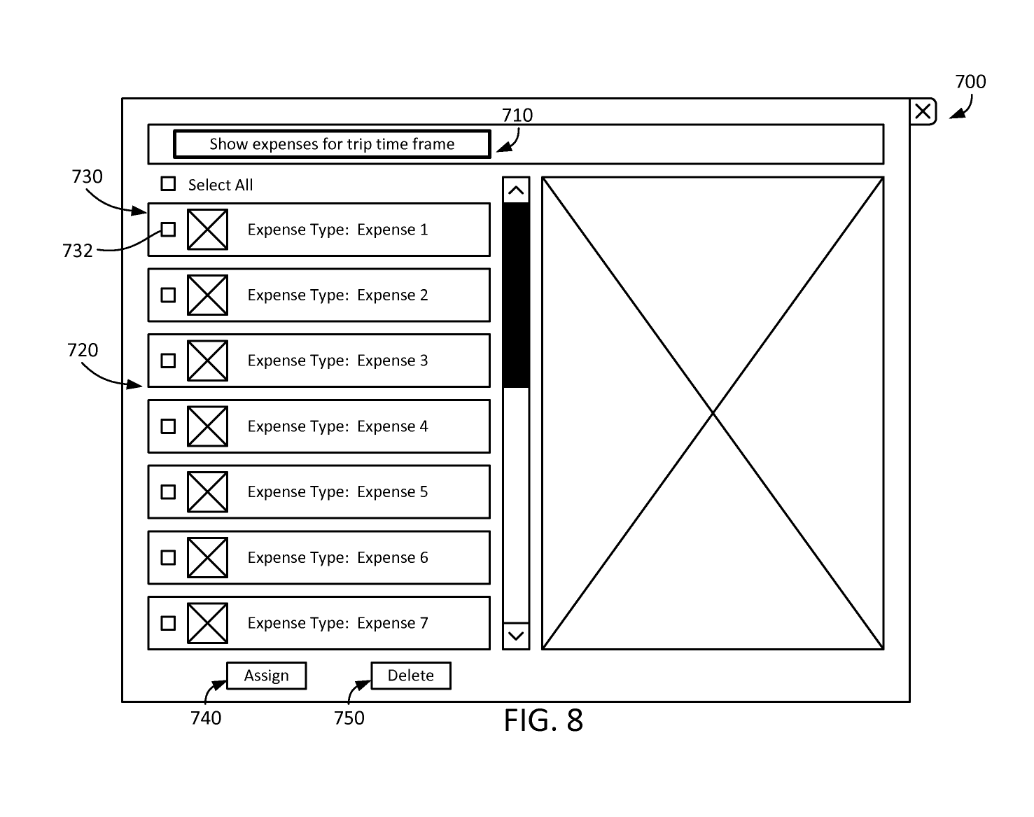

In other versions, if process 500 is initiated using unallocated expense feature 450 from within a selected expense report user interface 400, then a second user interface, such as user interface 700 shown in FIG. 8, may be presented to the user having one or more sorting inputs predetermined based, at least in part, on data associated with the expense report object. For example, referring back to FIG. 5, data for dates 314 may be used as the sorting input. In other implementations, location 316 may be used as the sorting input. Of course other data associated with the expense report object 310 and/or combinations thereof may be used as the sorting input. Of course it should be understood that other contexts, including those unrelated to expense items and/or expense reports, may be utilized to adapt or modify process 500. Thus, based upon the context of process 500, the sorting input may either be received from a user or received based upon data associated with an expense report object (step 530).

Based on the sorting input received, a determination of the unallocated expense items that satisfy the sorting input may be made (step 540). For example, if a date range is specified by a user and/or determined based upon date data from an expense report object, then only the unallocated expense items in the expense buffer having a date data element within that range may be displayed (step 550). In other versions, all the unallocated expense items may be displayed, but the display of the unallocated expense items may be sorted such that the expense items within the date range are shown at the top of the list while the expense items further from the date range are shown lower in the list based on the temporal distance from the date range (e.g., a date range of Jan. 1, 2012 through Jan. 3, 2012 would show expense items having a date of Jan. 1, 2012 through Jan. 3, 2012 first, with expense items having dates such as Jan. 4, 2012, Dec. 31, 2012, Jan. 8, 2012, etc. later). Of course, other sorting input may be used to determine the unallocated expense items to be displayed or otherwise sorted.

One or more selections may be received for one or more of the displayed expense items (step 560). For instance, referring briefly to FIGS. 7-8, a user may select one or more of the displayed expense items 630, 730 from an expense buffer 620, 720. Utilizing the determined context (step 520), an expense report item may be known such that the selected expense items may be associated with the existing expense report item (step 590) or an expense report selection may be received in response to a user being prompted to indicate an expense report with which to associate the selected expense items (step 570). In some instances, a new expense report object may be created when the user is prompted. The selected expense items may be associated with the selected or created expense report (step 580). In some instances, the expense items may be associated with the expense report object in response to a user input, such as a selection of an “Assign” button and/or otherwise.

Of course it should be understood that while process 500 has been described in reference to expense items and expense report items, process 500 may be implemented with other unstructured data items and/or groupings.

In some instances, one or more expense items may also be deleted from the expense buffer during process 500, though, in some implementations, deletion may be prohibited for certain expenses (e.g., for expenses made on a corporate card to help prevent fraud). In still further versions, if process 500 is implemented with an existing expense report, one or more expense items may automatically be selected (step 560) and associated with the existing expense report (step 590) base upon the determined sorting input. For example, if process 500 is initiated from an expense report having a date range of Jan. 1, 2012 to Jan. 4, 2012, then expense items within the expense buffer having dates within that date range may automatically be associated with the existing expense report. In other implementations, expense items having the same location as the existing expense report may be automatically associated with the existing expense report from the expense buffer. In yet a further version, expense items having both the same location and having a date within the date range as the existing expense report may be automatically associated with the existing expense report from the expense buffer. Still further implementations of process 500 may be used.

FIG. 7 depicts a first user interface 600 that may be presented to a user during process 500. First user interface 600 includes a sorting input feature 610, an expense buffer 620, an assignment feature 640, and a delete feature 650. Sorting input feature 610 of the present example is shown to include a first date entry field 612 and a second date entry field 614. Thus, first date entry field 612 and second date entry field 614 may be utilized by a user to enter a date range for the sorting input described herein. Of course, the foregoing is merely an example and sorting input feature 610 may include any other field, such as a location entry field, a region entry field, a type field, an amount field, and/or any other field or combination of fields.

Expense buffer 620 comprises any number of expense data items 630 that have not been associated or allocated to an expense report. In the present example, each expense data item 630 includes a checkbox 632 for selection/deselection of each expense data item 630. Other selection/deselection features may be provided in other implementations. With one or more expense data items 630 selected, a user may select the assignment feature 640 to select the expense report to which the selected expense data items 630 is to be assigned. Assignment feature 640 may include a dropdown box such that a user may select an expense report from a list populating the dropdown box or assignment feature 640 may include other features for selecting an expense report to assign the selected expense data items 630 to. In some versions, a delete feature 650 may be provided to delete one or more selected expense data items 630. Still other features for first user interface 600 may be provided.

FIG. 8 depicts a second user interface 700 that may be presented to a user during process 500. As discussed herein, second user interface 700 may be associated with an existing expense report. Second user interface 700 includes a sorting input feature 710, an expense buffer 720, an assignment feature 740, and a delete feature 750. Sorting input feature 710 of the present example comprises a selectable button that applies one or more sorting inputs to expense buffer 720 to sort and/or limit the display of expense data items 730 to those corresponding to the sorting input. The sorting input may include a date, a date range, a location, a region, a type, an amount, and/or any other sorting input or combinations thereof.

Expense buffer 720 comprises any number of expense data items 730 that have not been associated or allocated to an expense report. In the present example, each expense data item 730 includes a checkbox 732 for selection/deselection of each expense data item 730. Other selection/deselection features may be provided in other implementations. With one or more expense data items 730 selected, a user may select the assignment feature 740 to assign the one or more selected expense data items 730 to the existing expense report associated with second user interface 700. In some versions, selection of expense data items 730 by checkbox 732 may automatically associate the selected expense data item 730 with the existing expense report. In other versions, selection of sorting input feature 710 may automatically associate any expense data items 730 that meet the sorting input with the existing expense report. Still other implementations may be utilized to associate one or more expense data items 730 with an existing expense report. In some versions, a delete feature 750 may be provided to delete one or more selected expense data items 730. Still other features for second user interface 700 may be provided.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. cm What is claimed is:

1. A method for intelligent handling of one or more unstructured data items comprising:
receiving, at a processing circuit, a request for a buffer comprising one or more unstructured data items;
determining, by a processing circuit, a context for the request for the buffer;
receiving, at a processing circuit, a sorting input;
determining, at a processing circuit, one or more unstructured data items based, at least in part, on the sorting input, wherein each unstructured data item comprises one or more data elements, wherein the step of determining one or more unstructured data items is based, at least in part, on the sorting input comprises comparing the sorting input with a data element of the one or more data elements; and
associating, by a processing circuit, one or more of the determined unstructured data items with an expense report.

2. The method of claim 1 further comprising:
displaying one or more of the determined unstructured data items; and
receiving, at a processing circuit, one or more selections of one or more of the determined unstructured data items.

3. The method of claim 2 further comprising:
receiving, at a processing circuit, a selection of an expense report with which to associate the one or more selected unstructured data items.

4. The method of claim 3, wherein the one or more unstructured data items comprise one or more expense items, wherein the one of more data elements comprise a date and an amount.

5. The method of claim 4, wherein the one or more data elements further comprises at least one of the group of a location and a type.

6. The method of claim 5, wherein the sorting input comprises a date.

7. The method of claim 5, wherein the sorting input comprises a date range.

8. The method of claim 5, wherein the sorting input comprises a location.

9. The method of claim 2, wherein the one or more unstructured data items comprise one or more expense items, wherein the one of more data elements comprise a first date and an amount, wherein the expense report is associated with a second date, and wherein the sorting input comprises the second date associated with the expense report.

10. The method of claim 9, wherein the step of associating, by a processing circuit, one or more of the determined unstructured data items with an expense report comprises automatically associating the one or more determined expense items with the expense report.

11. The method of claim 4, wherein the context comprises a homepage user interface.

12. The method of claim 4, wherein the context comprises an expense report user interface.

13. The method of claim 12, wherein the expense report user interface is associated with the expense report, wherein the expense report is associated with at least one of a date, a date range, or a location.

14. The method of claim 1 further comprising:
creating, by a processing circuit, a grouping with which to associated the one or more selected unstructured data items.

15. A tangible computer-readable storage medium having instructions thereon that cause one or more processors to perform operations, the operations comprising:
receiving a request for an expense buffer comprising one or more expense items;
determining a context for the request for the expense buffer;
receiving a sorting input, wherein the sorting input comprises a date, a date range, a location, a type, or an amount;
determining one or more expense items based, at least in part, on the sorting input, wherein each expense item comprises one or more data elements, wherein the one or more data elements comprise a date, wherein the step of determining one or more expense items is based, at least in part, on the sorting input comprises comparing the sorting input with a data element of the one or more data elements;
displaying the one or more determined expense items;
receiving a selection of one or more determined expense items; and
associating the one or more selected expense items with an expense report.

16. The tangible computer-readable storage medium of claim 15, wherein the step of receiving the sorting input comprises receiving a date from an existing expense report.

17. The tangible computer-readable storage medium of claim 15, wherein the one or more data elements further comprise a location, wherein the sorting input comprises a date and a location.

18. The tangible computer-readable storage medium of claim 15 wherein the context comprises a homepage user interface or an expense report user interface.

19. A computerized method for intelligent handling of one or more expense items comprising:
receiving, at a processing circuit, a request for a buffer comprising one or more expense items;
determining, by a processing circuit, a context for the request for the buffer, wherein the context comprises a homepage user interface or an expense report user interface;
receiving, at a processing circuit, a sorting input, wherein the sorting input comprises a date, a date range, a location, a type, or an amount;
determining, at a processing circuit, one or more expense items based, at least in part, on the sorting input, wherein each expense item comprises one or more data elements, wherein the one or more data elements comprises a date, a location, and an amount, wherein the step of determining one or more expense items is based, at least in part, on the sorting input comprises comparing the sorting input with a data element of the one or more data elements; and
associating, by a processing circuit, one or more of the determined expense items with an expense report.

20. The computerized method of claim 19, wherein the step of receiving the sorting input comprises receiving a date from an existing expense report, wherein the step of associating, by a processing circuit, one or more of the determined expense items with an expense report comprises automatically associating the one or more of the determined expense items with the existing expense report.
